(19) United States
(12) Patent Application Publication
(10) Pub. No.: US 2013/0061072 A1
(43) Pub. Date: Mar. 7, 2013

(54) POWER SAVING NODE CONTROLLER

(71) Applicants: Kin-Yee Wong, Ottawa (CA); Joseph Rorai, Kanata (CA)

(72) Inventors: Kin-Yee Wong, Ottawa (CA); Joseph Rorai, Kanata (CA)

(73) Assignee: ALCATEL-LUCENT CANADA INC., Kanata (CA)

(21) Appl. No.: 13/225,817

(22) Filed: Sep. 6, 2011

(51) Int. Cl. G06F 1/32

(52) U.S. Cl. 713/320

(57) ABSTRACT

A method and apparatus are provided which allow telecommunication equipment to adjust its power consumption. A controller within a telecommunication node uses data to determine whether to reduce the power consumption of components within the node. The data can be real-time data fed to the node or controller, or data read from storage, or both, depending on the particular implementation. Various examples of data and decision-making are given.

### FIELD OF THE INVENTION

This invention relates to control of power usage within a telecommunication node, and more particularly to changing power usage of components in response to read data.

### BACKGROUND OF THE INVENTION

Energy and power consumption are increasingly becoming a significant business issue as energy costs and environmental impact are becoming more important in business models. Increased energy cost is reducing the profitability of telecom providers. Yet not all of the energy consumption of some telecommunication equipment is always needed. For example, a telecommunications node may provide a certain bandwidth capability, and this bandwidth capability requires a given amount of memory and processing power to support the amount of bandwidth capability. Yet this bandwidth capability and the resulting power usage is not always needed.

The environmental impact of energy usage may also be a social issue. A telecommunications operator that can argue that its equipment uses less energy may realize a benefit as consumers become increasingly concerned with the impact on the environment of energy usage.

As the cost of electricity rises, the cost of operating telecommunication equipment becomes more important. Any additional complexity required in deciding whether to operate the equipment at full capacity may be outweighed by the energy savings realizable by reducing operating capacity. Allowing the ability of telecommunication equipment to operate at a reduced capacity would allow less power to be consumed and would reduce the costs of operating the equipment, and may also provide social benefits.

### SUMMARY OF THE INVENTION

According to one aspect, a method of managing power usage in a telecommunication node is provided. Data is read, and using the data it is determined whether a power consumption level of each of at least one component within the telecommunication node is to be changed. The power consumption level of each component for which it is determined that the power consumption level is to be changed is changed. The data may include time of day, the amount of traffic entering the node, the amount of traffic being processed by the at least one component, a real-time cost of power, a listed cost of electricity, bandwidth requirements configured by a user, or function availability configured by a user.

According to another aspect, a telecommunication node is provided. The telecommunication node includes at least one component and a controller. The controller includes means for reading data. The controller also includes means for determining, using the data, whether a power consumption level of each component is to be changed. The controller also includes means for changing the power consumption level of each component for which it is determined that the power consumption level is to be changed

The methods of the invention may be stored as processing instructions on computer-readable non-transitory storage media, the instructions being executable by a computer processor.

The invention allows telecommunication equipment to control its power consumption. By using various data, real-time data and/or stored data depending on the particular implementation, the power saving level of the telecommunication node can be changed. Examples of data that can be used to make the decision as to whether to implement power saving in the node include user configured data or real-time data. Using factors such as these the power usage of the node can be reduced, thereby saving operating costs. The operator of the telecommunication node may decide to pass some cost savings on to a customer under certain circumstances, such as when a customer opts for a lower guarantee of service in exchange for a reduced cost.

### BRIEF DESCRIPTION OF THE DRAWINGS

The features and advantages of the invention will become more apparent from the following detailed description of the preferred embodiment(s) with reference to the attached figures, wherein:

FIG. 1 is a schematic diagram of hardware components within a telecommunication node according to one embodiment of the invention;

FIG. 2 is a flowchart of a method carried out by the controller of FIG. 1 according to one embodiment of the invention;

FIG. 3 is a flowchart of another method carried out by the controller of FIG. 1 according to one embodiment of the invention.

It is noted that in the attached figures, like features bear similar labels.

### DETAILED DESCRIPTION OF THE PREFERRED EMBODIMENTS

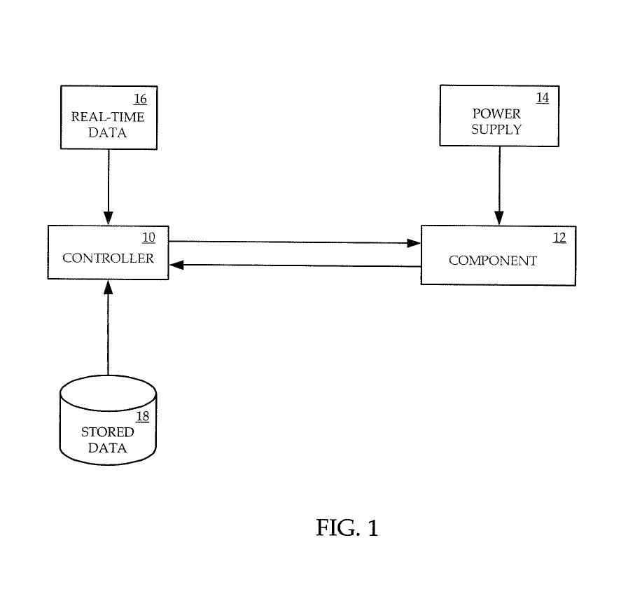

Referring to FIG. 1, a schematic diagram of a telecommunication node according to one embodiment of the invention is shown. The telecommunication node includes a controller 10, such as a program within a computer processor. The controller can communicate with a component 12 to control the power consumption level of the component. Examples of the component 12 are a service card, a redundancy card, a port, a fan, and a processor.

The component 12 draws electrical power from a power supply 14, the amount of power drawn by the component 12 depending on its power consumption level. The power consumption level of the component is an abstraction of the actual power consumed by the component 12. The power consumption level ranges from a maximum level, where the component 12 is drawing full power from the power supply 14 and operating at full capacity, to a minimum level, where the component 12 is drawing the least power possible from the power supply 14 and operating at a minimum capacity which may even be no capacity. The power consumption level of the component 12 can either be a binary state or can have one or more levels between these two extremes, such as partially reduced power. The meaning of “capacity” of the component 12 depends on the nature of the component 12. As examples, the capacity of a fan is the speed of the fan and how often the fan is running at this speed; the capacity of a port is whether traffic is passing through the port; the capacity of a redundancy card is whether the redundancy card is available; the capacity of a policing function is the amount of traffic able to be processed by the policing function.

The controller 10 can receive real-time data 16, which is fed as input to the node or read as a current parameter of the node. Examples of real-time data 16 are the real-time cost of electricity, time of day, amount of traffic entering the node, and amount of traffic being processed by the component 12. The controller 10 can also read stored data 18, such as data configured by a user. Examples of stored data 18 are listed cost of electricity, configured bandwidth requirements, and configured function availability.

The controller 10 is shown in FIG. 1 as receiving information from the component 12. This need not be the case, but in one example the controller 10 receives feedback of the amount of traffic being processed by the component 12. The controller uses this information in making a decision as to whether to change the capacity of the component 12. This feedback can be considered as real-time data, and from hereon any feedback from the component 12 will be considered to be real-time data 16.

The controller 10 is shown in FIG. 1 as both receiving real-time data 16 and reading stored data 18. Either of these is optional, and depending on the implementation either may be present alone or both may be present. In general, the controller 10 receives data, as received real-time data 16 and/or read stored data 18.

The power consumption of the component 12 may be affected in any manner. This may be as simple as reducing the operations of the component, or may be more complex such as by powering down the component and diverting traffic to a general purpose processor which replicates the functionality of the component but at a lower capacity and lower power usage. The latter is described more fully in the co-pending application entitled “Power Saving Hardware”, filed on Jan. 4, 2011 by the same applicants as for the present application and assigned U.S. Ser. No. 12/984,060, which is incorporated by reference herein.

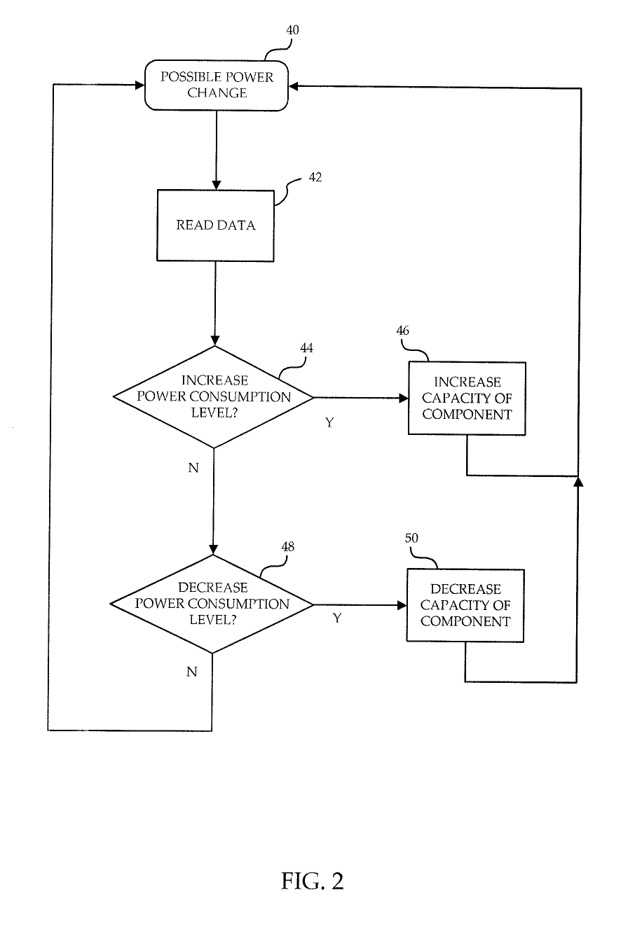

Referring to FIG. 2, a method carried out by the controller 10 according to one embodiment of the invention is shown. The method is triggered at step 40 when there is a possible change in power saving level of the telecommunication node. Examples of triggers are periodic automatic checks, an automatic check after stored data is changed, an automatic check when real-time date arrives at the telecommunication node, and manual prompting by a user. At step 42 the controller 10 reads data necessary for making a decision as to whether to change the power consumption level of the component 12. The controller may determine real-time data and/or may read stored data.

At step 44 the controller 10 determines whether the power consumption level of the component 12 is to be increased, using the data obtained at step 42. If so, then at step 46 the controller 10 changes the performance of the component 12 so that the capacity of the component 12 increases and the component 12 draws more power from the power supply 14. The controller then waits for receipt of another trigger to consider a power change.

If the controller determines at step 44 that the power consumption level of the component 12 is not to be increased, then at step 48 the controller 10 determines whether the power consumption level of the component 12 is to be decreased, using the data obtained at step 42. If so, then at step 50 the controller 10 changes the performance of the component 12 so that the capacity of the component 12 decreases and the component 12 draws less power from the power supply 14. The controller then waits for receipt of another trigger to consider a power change.

If the controller 10 determines at step 48 that the power consumption level of the component 12 is not to be decreased, then the controller waits for receipt of another trigger to consider a power change.

Other methods of performing the decision making and actions occurring at steps 44, 46, 48, and 50 may be used, as long as the method is logically equivalent to that described with reference to FIG. 2. The effect of these steps are that the controller 10 increases the capacity of the component if it determines that the power consumption level of the component is to be increased, and decreases the capacity of the component if it determines that the power consumption level of the component is to be decreased.

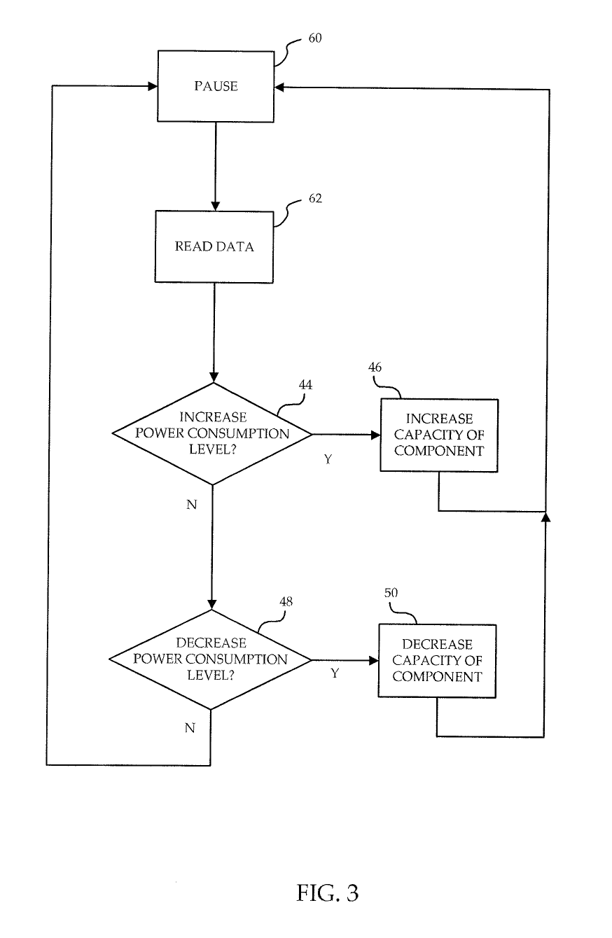

The method described in reference to FIG. 2 is only executed upon receipt of a trigger to consider the power consumption of the component 12. Referring to FIG. 3, another method carried out by the controller 10 according to one embodiment of the invention is shown. In this method, the controller 10 monitors the state and requirements of the telecommunication node at regular intervals by pausing at step 62 and then reading real-time data and/or stored data at step 62. Alternatively the controller 10 could monitor the state and requirements of the telecommunication node continuously, in which there is no pause at step 60. The decision making by the controller 10 and the adjustment of the capacity of the component 12 is otherwise the same as described above with reference to FIG. 2.

In the embodiments described above there is only one component 12. For example, only one component 12 is shown in FIG. 1. Alternatively there may be more than one component whose power draw from the power supply 14 is controlled by the controller 10, and whose power consumption level is altered by the controller 10. The methods described above with reference to FIG. 2 and FIG. 3 may be used by the controller to adjust the power consumption level of every such component, or just some of the components depending on the data read at step 42 or 62. In general, there is at least one such component 12.

Various examples of data read by the controller 10 and how this data is used to make the decision as to whether to change the power consumption level of the component 12 are given below.

As one example, a user sets time of recovery targets. Instead of a standard duration of outage before recovering from a fault, the user may configure the telecommunication node (or more abstractly, the entire system) to allow for a higher tolerance of outage before recovering. When the user makes this configuration change, the controller 10 is triggered to read data 42. In this example reading data 42 consists of reading the stored configuration data. The controller reads that the user has configured for higher tolerance of outage, and determines at step 48 to reduce the capacity of the component 12. At step 50 the controller 10 decreases the capacity of the component 12, which in this case could be powering down of a redundancy card, reducing the speed of a CPU, reducing the speed of a CPU core, or reduction of capacity of other components involved in providing fault recovery. If the configuration is changed to allow for regular tolerance of shorter outage, then the controller 10 increases the capacity of each component 12.

As another example, a user sets a level of service guarantee. The user may select among different levels of service. Lower levels of service consume less power. For example, a lower level of service may allow jitter or cell delay to increase, to allow other packets to take precedence if collisions occur, or to lower guaranteed bandwidth. The controller 10 reads the stored configuration data at step 42, either periodically or in response to a configuration change, and based on the stored guaranteed level of service determines whether to change the power consumption level of one or more components, which in this case could be shutting down a port, using only part of the maximum memory available on a card, or reducing the speed of processors responsible for processing traffic. If the configuration is changed to allow for a higher level of service guarantee, then the controller 10 increases the capacity of each component 12.

As another example, a user configures the node or equipment within the node to reduce the useful life of the equipment yet realizes lower operating costs. For example the controller 10 reads the stored configuration data, which indicates that a reduced useful life of the equipment is acceptable to the user. The controller determines that this means that the power consumption level of a fan is to be reduced, and lowers the speed of the fan. The higher temperature which results may reduce the lifetime of some equipment, but the power usage of the fan is reduced.

As another example, a user disables some functionality of the node by setting a configuration of the node indicating that the functionality is not to be available. The controller 10 reads stored function availability, and based on this data determines whether to change the power consumption level of the component 12. For example, the configuration of the node may be changed to indicate that less buffering is to occur, which allows the controller to reduce power usage of some memories, or 1588 clock recovery is to be disabled, which allows the controller to power off an appropriate processor.

As another example, a user configures the node to reduce statistics record collection or to reduce OAM of the node. As part of an OAM function, packets are sometimes generated by the telecommunication node. These generated packets are then artificially infected and routed around the network of which the telecommunication node is a part. The generation and processing of these packets uses additional hardware resources. If the controller 10 reads as part of the stored data 18 that the user has configured for reduced statistics record collection, then the controller 10 reduces the power consumption level of components involved in the generation and processing of these packets. As a more specific example, if the OAM functionality were on a single core of a multi-core processor then the controller 10 reduces the power consumption level of the multi-core processor by shutting down the single core dedicated to OAM. The remaining cores of the multi-core processor can add any reduced OAM functionality, if any, to their workloads.

As another example, the controller 10 reads as real-time data the time of day. The controller 10 may determine that the maximum bandwidth capacity of a processor can be reduced during historically less busy times. If the time of day indicated by the real-time data indicates that the current time is within a historically less busy time, then the controller either reduces the amount of memory available for processing the traffic or switches traffic processing from the processor to a general purpose CPU operating at a lower maximum bandwidth but at a lower power usage.

As another example, the controller 10 reads as real-time data the real-time cost of power if such is provided to the telecommunication node, as described more fully in the co-pending application entitled “Real-Time Power Cost Feed”, filed on Jan. 4, 2011 by the same applicants as for the present application and assigned U.S. Ser. No. 12/984,026, which is incorporated by reference herein. If the controller 10 reads that the real-time cost of power has been increased, the controller 10 may determine that the cost of power has exceeded a threshold and that the power consumption level of one or more components is to be reduced. In such an example, the functionality, bandwidth capacity, or lifetime of the component may be reduced, including reducing the amount of memory available to a processor, but this may be acceptable in order to avoid increased operating costs.

The methods carried out by the controller are preferably implemented as logical instructions in the form of software on one or more processors within the telecommunication node. Alternatively, the logical instructions may be implemented as hardware, or as a combination of software and hardware. If in the form of software, the logical instructions may be stored on a computer-readable non-transitory storage medium in a form executable by a computer processor.

The embodiments presented are exemplary only and persons skilled in the art would appreciate that variations to the embodiments described above may be made without departing from the spirit of the invention. The scope of the invention is solely defined by the appended claims.

I/We claim:

1. A method of managing power usage in a telecommunication node, comprising:
reading data;
determining, using the data, whether a power consumption level of each of at least one component within the telecommunication node is to be changed; and
changing the power consumption level of each component for which it is determined that the power consumption level is to be changed.

2. The method of claim 1 wherein reading data comprises reading at least one of reading real-time data and reading stored data.

3. The method of claim 2 wherein the real-time data comprises at least one of time of day, the amount of traffic entering the node, the amount of traffic being processed by the at least one component, and a real-time cost of power.

4. The method of claim 2 wherein the stored data comprises configurations set by a user.

5. The method of claim 2 wherein the stored data comprises at least one of listed cost of electricity, bandwidth requirements configured by a user, and availability configured by a user.

6. The method of claim 1 wherein each of the at least one component comprises a port, a card, a redundancy card, a processor, or a fan.

7. The method of claim 1 wherein the at least one component comprises a redundancy card, wherein reading data comprises reading a configured time of recovery, and wherein changing the power consumption level of each component comprises powering down the redundancy card.

8. The method of claim 1 wherein the at least one component comprises a processor, wherein reading data comprises reading a configured level of service, wherein determining whether the power consumption level of each component is to be changed comprises determining whether the configured level of service has changed, and wherein changing the power consumption level of each component comprises reducing the amount of memory used by the processor.

9. The method of claim 1 wherein the at least one component comprises a fan, wherein determining whether the power consumption level of each component is to be changed comprises determining if the node or equipment within the node has been configured to accept having a reduced useful life, and wherein changing the power consumption level of each component comprises reducing the speed of the fan.

10. The method of claim 1 wherein reading data comprises reading real-time data indicating a time of day, wherein the at least one component comprises a processor, and wherein changing the power consumption level of the processor comprises altering the amount of memory available to the processor.

11. The method of claim 1 wherein reading data comprises reading real-time data indicating a cost of power, wherein the at least one component comprises a processor, and wherein changing the power consumption level of the processor comprises altering the amount of memory available to the processor.

12. The method of claim 1 further comprising receiving a trigger prior to carrying out the remaining steps.

13. A telecommunication node comprising:
at least one component; and
a controller comprising:
means for reading data;
means for determining, using the data, whether a power consumption level of each component is to be changed; and
means for changing the power consumption level of each component for which it is determined that the power consumption level is to be changed.

14. The telecommunication node of claim 13 wherein the means for reading data comprise means for reading real-time data, and wherein the data comprises at least one of time of day, the amount of traffic entering the node, the amount of traffic being processed by the component, and real-time cost of power.

15. The telecommunication node of claim 13 wherein the means for reading data comprise means for reading stored data, and wherein the data comprises at least one of listed cost of electricity, bandwidth requirements configured by a user, and availability configured by a user.

16. The telecommunication node of claim 13 wherein the at least one component comprises a redundancy card, wherein the means for reading data comprise means for reading a configured time of recovery, and wherein means for changing the power consumption level of each component comprises means for powering down the redundancy card.

17. The telecommunication node of claim 13 wherein the at least one component comprises a processor, wherein the means for reading data comprise means for reading a configured level of service, wherein the means determining whether the power consumption level of each component is to be changed comprise means for determining whether the configured level of service has changed, and wherein the means for changing the power consumption level of each component comprise means for reducing the amount of memory used by the processor.

18. The telecommunication node of claim 13 wherein the at least one component comprises a fan, wherein the means for determining whether the power consumption level of each component is to be changed comprise means for determining if the node or equipment within the node has been configured to accept having a reduced useful life, and wherein the means for changing the power consumption level of each component comprise means for reducing the speed of the fan.

19. The telecommunication node of claim 13 wherein the means for reading data comprise means for reading real-time data indicating a time of day, wherein the at least one component comprises a processor, and wherein the means for changing the power consumption level of the processor comprise means for altering the amount of memory available to the processor.

20. The telecommunication node of claim 13 wherein the means for reading data comprise means for reading real-time data indicating a cost of power, wherein the at least one component comprises a processor, and wherein the means for changing the power consumption level of the processor comprise means for altering the amount of memory available to the processor.
